(19) United States
(12) Patent Application Publication
(10) Pub. No.: US 2026/0217967 A1
(43) Pub. Date: Jul. 30, 2026

(54) THERMOPLASTIC RESIN COMPOSITION AND USE THEREOF

(71) Applicant: KANEKA CORPORATION, Osaka-shi (JP)

(72) Inventors: Takenobu SUNAGAWA, Settsu-shi (JP); Arisa SONOYAMA, Settsu-shi (JP)

(73) Assignee: KANEKA CORPORATION, Osaka-shi (JP)

(21) Appl. No.: 19/629,107

(22) Filed: Mar. 26, 2026

Related U.S. Application Data
(63) Continuation of application No. PCT/JP2024/035544, filed on Oct. 4, 2024.

(30) Foreign Application Priority Data
Oct. 4, 2023 (JP) 2023-172663

(51) Int. Cl. C08L 67/08

(52) U.S. Cl. CPC C08L 67/08; C08L 2205/03; C08L 2205/22

(57) ABSTRACT

An object is to provide a thermoplastic resin composition capable of providing a molded article having a large tensile strain. The object is achieved by a thermoplastic resin composition comprising a P3HA-based resin component (A) comprising a P3HA-based copolymer (a-1) having a weight average molecular weight of 200,000 to 1,000,000 and a P3HA-based copolymer (a-2) having a weight average molecular weight larger than that of the copolymer (a-1), and crosslinked resin particles (B) comprising a polyhydroxyalkanoate-based resin and having a gel fraction of 50% or more.

### TECHNICAL FIELD

The present invention relates to a thermoplastic resin composition and use thereof.

### BACKGROUND ART

Plastic waste has become a cause of imposing a burden on the global environment, such as impacts on ecosystems, generation of harmful gases during combustion, and global warming due to a large amount of combustion heat. Development of biodegradable plastics as materials capable of solving this problem has become active.

Patent Literature 1 describes a thermoplastic resin composition formed by blending 0.1 to 20 parts by weight of poly(3-hydroxyalkanoate) particles having an average particle diameter of 300 μm or less based on 100 parts by weight of poly(3-hydroxybutyrate-co-3-hydroxyhexanoate), and biodegradable and excellent in environmental compatibility.

### CITATION LIST

### Patent Literature

Patent Literature 1: Japanese Patent Application Publication, Tokukai, No. 2004-161802

### SUMMARY OF INVENTION

### Technical Problem

However, the conventional technology as described above was not sufficient from the viewpoint of tensile strain of a molded article of a thermoplastic resin composition, and there remained room for further improvement.

One embodiment of the present invention has been made in view of the above situation, and an object thereof is to provide a thermoplastic resin composition capable of providing a molded article having a larger tensile strain.

### Solution to Problem

In order to solve the above problem, a thermoplastic resin composition according to one embodiment of the present invention is a thermoplastic resin composition comprising a poly(3-hydroxyalkanoate)-based resin component (A) and crosslinked resin particles (B) comprising a polyhydroxyalkanoate-based resin and having a gel fraction of 50% or more, wherein the poly(3-hydroxyalkanoate)-based resin component (A) contains: a poly(3-hydroxyalkanoate)-based copolymer (a-1) having a weight average molecular weight of 200,000 to 1,000,000; and a poly(3-hydroxyalkanoate)-based copolymer (a-2) having a weight average molecular weight larger than that of the poly(3-hydroxyalkanoate)-based copolymer (a-1).

### Advantageous Effect of Invention

One embodiment of the present invention exhibits the effect that there can be provided a thermoplastic resin composition capable of providing a molded article having a larger tensile strain.

### DESCRIPTION OF EMBODIMENTS

Although one embodiment of the present invention is described below, the present invention is not limited thereto. The present invention is not limited to the respective configurations described below, and various modifications can be made within the scope indicated in the claims. Embodiments or Examples obtained by combining the technical means respectively disclosed in different embodiments or Examples are also included within the technical scope of the present invention. Furthermore, new technical characteristics can be formed by combining the technical means respectively disclosed in the embodiments. It should be noted that all academic documents and patent documents described in the present specification are incorporated herein by reference. Also, unless otherwise specified in the present specification, “A to B” representing a numerical range is intended to mean “A or more (including A and more than A) and B or less (including B and less than B)”.

### [1. Thermoplastic Resin Composition]

A thermoplastic resin composition according to one embodiment of the present invention is a thermoplastic resin composition comprising a poly(3-hydroxyalkanoate)-based resin component (A) and crosslinked resin particles (B) comprising a polyhydroxyalkanoate-based resin and having a gel fraction of 50% or more, wherein the poly(3-hydroxyalkanoate)-based resin component (A) contains: a poly(3-hydroxyalkanoate)-based copolymer (a-1) having a weight average molecular weight of 200,000 to 1,000,000; and a poly(3-hydroxyalkanoate)-based copolymer (a-2) having a weight average molecular weight larger than that of the poly(3-hydroxyalkanoate)-based copolymer (a-1).

In the present specification, the “poly(3-hydroxyalkanoate)-based resin” may be referred to as “P3HA-based resin” in some cases, the “poly(3-hydroxyalkanoate)-based copolymer” may be referred to as “P3HA-based copolymer” in some cases, and the “thermoplastic resin composition according to one embodiment of the present invention” may be referred to as “the present resin composition” in some cases.

The present inventors, in the course of intensive studies on a thermoplastic resin composition comprising a P3HA-based resin, have found that a thermoplastic resin composition comprising a P3HA-based resin component and crosslinked resin particles comprising a polyhydroxyalkanoate-based resin and having a gel fraction of 50% or more, wherein two types of P3HA-based copolymers having different molecular weights are used as the P3HA-based resin component, exhibits a larger tensile strain in a molded article formed by molding the thermoplastic resin composition, and thus have completed the present invention.

The present resin composition comprises a P3HA-based resin being a biodegradable plastic, and thus has biodegradability. Therefore, the present resin composition is expected to be useful as an environmentally friendly thermoplastic resin composition and molded article capable of addressing problems such as plastic waste. More specifically, according to one embodiment of the present invention, there can be provided a thermoplastic resin composition or a molded article having biodegradability, and as a result, soil pollution and/or marine pollution when they are discarded can be suppressed. That is, one embodiment of the present invention is expected to contribute, for example, to achieving Sustainable Development Goals (SDGs) such as Goal 12 “Ensure sustainable consumption and production patterns” and/or Goal 14 “Conserve and sustainably use the oceans, seas and marine resources for sustainable development”.

Hereinafter, each component that may be contained in the present resin composition will be described in detail.

### [1-1] P3HA-Based Resin Component (A)

The present resin composition comprises a P3HA-based resin component (A). Hereinafter, the “P3HA-based resin component (A)” may be referred to as “component (A)” in some cases. The component (A) can also be said to be a matrix resin in the present resin composition.

The component (A) is a composition comprising a poly(3-hydroxyalkanoate)-based copolymer (a-1) having a weight average molecular weight of 200,000 to 1,000,000, and a poly(3-hydroxyalkanoate)-based copolymer (a-2) having a weight average molecular weight larger than that of the poly(3-hydroxyalkanoate)-based copolymer (a-1). Hereinafter, the “poly(3-hydroxyalkanoate)-based copolymer (a-1)” may be referred to as “copolymer (a-1)” in some cases, and hereinafter, the “poly(3-hydroxyalkanoate)-based copolymer (a-2)” may be referred to as “copolymer (a-2)” in some cases. The component (A) only needs to be a composition comprising at least two types of P3HA-based resins, namely the copolymer (a-1) and the copolymer (a-2), and may be a composition composed only of the two types of P3HA-based resins, namely the copolymer (a-1) and the copolymer (a-2), or may be a composition comprising, in addition to the copolymer (a-1) and the copolymer (a-2), another P3HA-based resin.

A P3HA-based resin is a polymer containing, as an essential repeating unit, a 3-hydroxyalkanoic acid repeating unit represented by the formula: [—CHR—CH₂—CO—O—], wherein R is an alkyl group represented by CₙH₂ₙ₊₁ and n is an integer of 1 or more and 15 or less (hereinafter, the “repeating unit” may be simply referred to as “unit” in some cases). The P3HA-based resin may be a copolymer composed of two or more types of 3-hydroxyalkanoic acid repeating units, or may be a copolymer composed of a 3-hydroxyalkanoic acid repeating unit and another repeating unit. In the present specification, the “P3HA-based resin” is intended to mean a polymer (copolymer) containing 50 mol % or more of a 3-hydroxyalkanoic acid repeating unit out of the total monomer repeating units (100 mol %). In other words, the copolymer (a-1) and the copolymer (a-2) are copolymers containing 50 mol % or more of a 3-hydroxyalkanoic acid repeating unit out of the total monomer repeating units (100 mol %).

It is more preferable that the copolymer (a-1) and/or the copolymer (a-2) contains 60 mol % or more of the 3-hydroxyalkanoic acid repeating unit out of the total monomer repeating units (100 mol %), and it is still more preferable that the copolymer (a-1) and/or the copolymer (a-2) contains 70 mol % or more of the 3-hydroxyalkanoic acid repeating unit.

The P3HA-based resin, namely the copolymer (a-1) and/or the copolymer (a-2), is not particularly limited, and may be a homopolymer containing the aforementioned repeating unit, or a copolymer containing the aforementioned repeating unit. The copolymer may be, for example, a copolymer of two or more types of monomers selected from the group consisting of 3-hydroxybutyric acid, 3-hydroxypropionic acid, 3-hydroxypentanoic acid, 3-hydroxyhexanoic acid, 3-hydroxyheptanoic acid, 3-hydroxyoctanoic acid, 3-hydroxynonanoic acid, 3-hydroxydecanoic acid, 3-hydroxyundecanoic acid, 3-hydroxydodecanoic acid, 3-hydroxytridecanoic acid, 3-hydroxytetradecanoic acid, 3-hydroxyhexadecanoic acid, and 3-hydroxyoctadecanoic acid. Alternatively, the copolymer may be a copolymer of a monomer mixture containing the above-described monomer as the main monomer and further containing, as a comonomer, a hydroxyalkanoic acid repeating unit other than the 3-hydroxyalkanoic acid repeating unit (such as 4-hydroxybutyric acid). In the present specification, a copolymer containing a monomer-derived unit X as the main monomer-derived unit and containing a monomer-derived unit Y as a comonomer-derived unit may be referred to as “poly(X-co-Y)”. It can also be said that the poly(X-co-Y) is a copolymer containing an X repeating unit and a Y repeating unit.

More specifically, examples of the P3HA-based resin, namely the copolymer (a-1) and/or the copolymer (a-2), include poly(3-hydroxybutyrate-co-3-hydroxyhexanoate) (hereinafter referred to as “P3HB3HH” in some cases), poly(3-hydroxybutyrate-co-4-hydroxybutyrate) (hereinafter referred to as “P3HB4HB” in some cases), poly(3-hydroxybutyrate-co-3-hydroxypropionate), poly(3-hydroxybutyrate-co-3-hydroxyvalerate), poly(3-hydroxybutyrate-co-3-hydroxyoctanoate), poly(3-hydroxybutyrate-co-3-hydroxyoctadecanoate), poly(3-hydroxybutyrate-co-3-hydroxydecanoate), and poly(3-hydroxybutyrate-co-3-hydroxyvalerate-co-3-hydroxyhexanoate). Furthermore, during microbial production of the P3HA, a minute amount (about 1 mol % or less) of a monomer may be copolymerized, but if the copolymerization of such a monomer does not significantly affect the physical properties of the resulting P3HA, that monomer is regarded as not copolymerized, and the P3HA is referred to by a name that does not include the monomer. The copolymer (a-1) and the copolymer (a-2) may be the same type of P3HA-based resin, or may be different types of P3HA-based resins.

From the viewpoints that industrial production using plant raw materials by microorganisms is possible and that contribution can be made to resource circulation (carbon neutrality), thereby providing a resin with a lower environmental burden, among P3HA-based resins, the copolymer (a-1) and/or the copolymer (a-2) is more preferably a copolymer containing a 3-hydroxyalkanoic acid repeating unit in which R is an alkane having 1 carbon atom in the above formula, that is, a 3-hydroxybutyrate (3HB) repeating unit, and another hydroxyalkanoic acid repeating unit other than the 3-hydroxybutyrate unit.

The P3HA can be produced by microorganisms. Such microbially produced P3HA is normally P3HA constituted only by a D-form (R-form) 3-hydroxyalkanoic acid repeating unit. Among microbially produced P3HA, P3HB, P3HB3HH, and P3HB4HB are preferable from the viewpoint of ease of industrial production, and P3HB3HH and P3HB4HB are more preferable.

When the copolymer (a-1) and/or the copolymer (a-2) is a copolymer containing a 3HB repeating unit, or a copolymer of a 3HB repeating unit and another hydroxyalkanoate unit other than the 3-hydroxybutyrate unit, from the viewpoint of a balance between flexibility and strength, in the copolymer (a-1) and/or the copolymer (a-2), the composition ratio of the 3HB repeating unit is preferably 77 mol % to 99 mol % in the total monomer repeating units (100 mol %), more preferably 80 mol % to 98 molo, and still more preferably 85 mol % to 97 mol %. When the composition ratio of the 3HB repeating unit in the copolymer (a-1) and/or the copolymer (a-2) is within the above range, there is an advantage that both flexibility and strength (rigidity) can be achieved, and productivity can also be improved. It should be noted that the monomer composition ratio in the copolymer as the P3HA-based resin can be measured by gas chromatography or the like (for example, see International Publication No. WO 2014/020838). As the copolymer (a-1) and/or the copolymer (a-2), copolymers having the same composition ratio of the 3HB repeating unit may be used, or two or more types of copolymers having different composition ratios may be used in combination.

When the copolymer (a-1) and the copolymer (a-2) are copolymers containing a 3HB repeating unit, or copolymers of a 3HB repeating unit and another hydroxyalkanoate unit other than the 3-hydroxybutyrate unit, it is also preferable that the composition ratio of the 3HB repeating unit in the copolymer (a-1) in the total monomer repeating units (100 mol %) is within the aforementioned range, and that the composition ratio of the 3HB repeating unit in the copolymer (a-2) in the total monomer repeating units (100 mol %) is in the range of 85 mol % to 92 molo, or 85 mol % to 90 mol %. When the composition ratios of the 3HB repeating unit in the copolymer (a-1) and the copolymer (a-2) are within the above ranges, there is an advantage that a molded article formed by molding the present resin composition exhibits a larger tensile strain.

The microorganisms for producing the P3HA-based resin are not particularly limited, as long as they have the ability to produce the P3HA-based resin. For example, Bacillus megaterium, discovered in 1925, was the first known bacterium for producing poly(3-hydroxybutyrate) (P3HB), which is a homopolymer of 3-hydroxybutyric acid, and other naturally occurring microorganisms such as Cupriavidus necator (formerly classified as Alcaligenes eutrophus or Ralstonia eutropha) and Alcaligenes latus are also known. In these microorganisms, the P3HB accumulates within the cells.

In addition, as bacteria for producing copolymers of the 3HB repeating unit and other hydroxyalkanoic acid repeating units, Aeromonas caviae, which is a P3HB3HH-producing bacterium, Alcaligenes eutrophus, which is a poly(3-hydroxybutyrate-co-4-hydroxybutyrate)-producing bacterium, and others are known. In particular, Alcaligenes eutrophus AC32 (FERM BP-6038), in which genes of the P3HA synthase group have been introduced to improve the productivity of P3HB3HH (T. Fukui, Y. Doi, J. Bateriol., 179, p. 4821-4830 (1997)), is preferable. Microbial cells in which the P3HA-based resin is accumulated by culturing such microorganisms under appropriate conditions are used. In addition to the above, recombinant microorganisms into which various P3HA synthesis-related genes have been introduced may be used depending on the desired P3HA-based resin, and optimization of the culture conditions, including the type of substrate, may be performed.

The weight average molecular weight of the copolymer (a-1) is preferably 200,000 to 1,000,000, more preferably 250,000 to 900,000, and still more preferably 300,000 to 800,000. When the weight average molecular weight of the copolymer (a-1) is within the above range, there is an advantage that the molded article is excellent in toughness. In addition, the weight average molecular weight of the copolymer (a-2) is not particularly limited as long as it is larger than the weight average molecular weight of the copolymer (a-1). A thermoplastic resin composition that uses, as the P3HA-based resin component, the copolymer (a-1) having a weight average molecular weight within the aforementioned range and the copolymer (a-2) having a weight average molecular weight larger than that of the copolymer (a-1) has an advantage that a molded article formed by molding the thermoplastic resin composition exhibits a larger tensile strain. The weight average molecular weight of the copolymer (a-2) is more preferably larger than the weight average molecular weight of the copolymer (a-1) by 200,000 or more, still more preferably by 250,000 or more, and still more preferably by 300,000 or more. The weight average molecular weight of the copolymer (a-2) is not particularly limited as long as it is larger than the weight average molecular weight of the copolymer (a-1); however, for example, it is preferably 400,000 to 3,000,000, more preferably 450,000 to 2,000,000, and still more preferably 500,000 to 1,500,000. The weight average molecular weight of the copolymer (a-2) may also be 600,000 to 1,500,000, or 700,000 to 1,500,000. When the weight average molecular weight of the copolymer (a-2) is within the above range, there is an advantage that the tensile strain of the molded article can be more easily increased without impairing processability into the molded article.

In the present specification, the weight average molecular weight of the P3HA-based resin (that is, the copolymer (a-1) and the copolymer (a-2)) and the weight average molecular weight of the polyhydroxyalkanoate-based resin described later are values measured by a gel permeation chromatography (GPC) method. For example, the measurement is carried out using “High Performance Liquid Chromatograph 20A System” manufactured by Shimadzu Corporation, using polystyrene gels (such as “K-G 4A” or “K-806M” manufactured by Showa Denko K.K.) as columns, and using chloroform as the mobile phase, and the values are measured in terms of polystyrene. In the above measurement, a calibration curve obtained by measuring polystyrene of known molecular weights by GPC can be used, and in this case, the calibration curve can be prepared using polystyrene with weight average molecular weights of 31, 400, 197,000, 668,000, and 1, 920,000. In addition, as the column in the GPC for preparing the calibration curve, any column appropriate for measuring the molecular weight of polystyrene may be used.

The amount of the copolymer (a-1) in the component (A) is not particularly limited; however, it is preferably 80 parts by weight to 99 parts by weight, more preferably 83 parts by weight to 97 parts by weight, and still more preferably 85 parts by weight to 95 parts by weight, based on 100 parts by weight of the component (A). By setting the amount of the copolymer (a-1) to 80 parts by weight to 99 parts by weight based on 100 parts by weight of the component (A), the tensile strain of the resulting molded article can be further increased. Also, the amount of the copolymer (a-2) in the component (A) is not particularly limited either; however, it is preferably 1 part by weight or more and less than 20 parts by weight, more preferably 3 parts by weight or more and less than 17 parts by weight, and still more preferably 5 parts by weight or more and less than 15 parts by weight.

The gel fraction of the component (A) in the present resin composition is not particularly limited; however, from the viewpoint that moldability becomes good, it is preferably less than 50%, more preferably 40% or less, still more preferably 30% or less, and may be 20% or less, may be 10% or less, or may be 0%. The gel fraction of the component (A) is influenced by the amount of a crosslinked structure possessed by the component (A) (in other words, by each P3HA-based resin contained in the component (A)), and specifically, a lower gel fraction of the component (A) means that the amount of the crosslinked structure possessed by the P3HA-based resin contained in the component (A) is smaller. That is, it is preferable that the component (A) in the present resin composition comprises a P3HA-based resin having a small amount of a crosslinked structure or having no crosslinked structure. It should be noted that the gel fraction of a P3HA-based resin not crosslinked in the production process is normally 0%.

From the above viewpoint, the gel fractions of both the copolymer (a-1) and the copolymer (a-2) are preferably less than 50%, more preferably 40% or less, still more preferably 30% or less, and may be 20% or less, may be 10% or less, or may be 0%. By controlling the gel fraction of each P3HA-based resin contained in the component (A) (in particular, the copolymer (a-1) and the copolymer (a-2)) within the above range, the gel fraction of the component (A) can also be controlled within a similar range.

It should be noted that, in the present specification, the gel fraction of the P3HA-based resin (composition) is a value measured as follows:
(1) A dried product of the P3HA-based resin (composition) is added to chloroform so as to achieve a concentration of 0.7% by weight, and the resulting mixture is held at 60° C. for 30 minutes to obtain a chloroform solution;
(2) Thereafter, the chloroform solution is allowed to stand at room temperature for 3 hours, and the chloroform solution is then filtered through a membrane filter having a pore size of 0.45 μm. Here, during filtration, filtration was performed while sufficiently washing the inside of the container and the filter by pouring chloroform thereover a plurality of times, thereby preventing loss; and
(3) The gel remaining on the filter is dried, the weight of the dried gel is measured together with the filter, and the gel fraction is calculated according to the following expression:

$$Expression$$

$$Gel fraction = ( Weight of the filter including the dried gel - Weight of the filter alone ) / Weight of the P 3 HA - based resin ( composition ) used for the measured \times 100 ( \% ) .$$

The component (A) may comprise a P3HA-based resin other than the copolymer (a-1) and the copolymer (a-2) (another P3HA-based resin). Examples of such another P3HA-based resin include various P3HA-based resins having a weight average molecular weight of less than 200,000.

The amount of the other P3HA-based resin in the component (A) is not particularly limited as long as the effects of the present invention are not impaired; however, it is preferably 0.1 to 10 parts by weight, and more preferably 0.5 to 5 parts by weight, based on 100 parts by weight of the total amount of the component (A).

### [1-2] Crosslinked Resin Particles (B)

The present resin composition comprises crosslinked resin particles (B) comprising a polyhydroxyalkanoate-based resin and having a gel fraction of 50% or more. Hereinafter, the “crosslinked resin particles (B)” may be referred to as “component (B)” in some cases. The present resin composition can provide a molded article excellent in impact resistance by comprising the component (B). In other words, the component (B) can function as a modifier or an impact resistance improver for a thermoplastic resin.

The amount of the crosslinked resin particles (B) in the present resin composition is 10 parts by weight to 60 parts by weight based on 100 parts by weight of the total amount of the P3HA-based resin component (A) and the crosslinked resin particles (B). According to this configuration, the thermoplastic resin composition can provide a molded article excellent in impact resistance. The amount of the crosslinked resin particles (B) in the present resin composition may be 15 parts by weight or more, may be 20 parts by weight or more, or may be 25 parts by weight or more, based on 100 parts by weight of the total of the P3HA-based resin component (A) and the crosslinked resin particles (B). The amount of the crosslinked resin particles (B) in the present resin composition is preferably 55 parts by weight or less, more preferably 50 parts by weight or less, and particularly preferably 45 parts by weight or less, based on 100 parts by weight of the total of the P3HA-based resin component (A) and the crosslinked resin particles (B).

### <Polyhydroxyalkanoate-Based Resin>

In the present specification, the “polyhydroxyalkanoate-based resin” may be referred to as “PHA-based resin” in some cases.

The PHA-based resin is a general term for polymers containing a hydroxyalkanoic acid as a monomer unit (monomer repeating unit) and generally has biodegradability. The PHA-based resin is aliphatic polyester and is preferably polyester that does not contain an aromatic ring. In the present specification, the PHA-based resin refers to a resin containing 50 mol % or more of a hydroxyalkanoic acid repeating unit out of the total monomer repeating units (100 mol %). It is preferable that the PHA-based resin contains 60 mol % or more of a hydroxyalkanoic acid repeating unit out of the total monomer repeating units (100 mol %), and it is more preferable that the PHA-based resin contains 70 mol % or more of a hydroxyalkanoic acid repeating unit.

The PHA-based resin is not particularly limited. Examples of the PHA-based resin include polyglycolic acid, P3HA-based resins, and poly(4-hydroxyalkanoate)-based resins. As the PHA-based resin, one type may be used alone, or two or more types may be used in combination. It is preferable that the PHA-based resin comprises a P3HA-based resin, and it is more preferable that the PHA-based resin is a P3HA-based resin (in other words, it is constituted only by a P3HA-based resin).

With respect to the P3HA-based resin, it is as described in [1-1] P3HA-Based Resin Component (A). The P3HA-based resin contained in the component (B) may be a homopolymer or a copolymer containing the monomer-derived repeating units exemplified in [1-1]. More specifically, examples of the P3HA-based resin contained in the component (B) include poly(3-hydroxybutyrate) (P3HB), which is a homopolymer of 3HB, poly(3-hydroxybutyrate-co-3-hydroxyhexanoate) (P3HB3HH), and poly(3-hydroxybutyrate-co-4-hydroxybutyrate) (P3HB4HB). As the P3HA-based resin, only one type may be used alone, or two or more types may be used in combination.

It is also preferable that the P3HA-based resin contained in the component (B) contains a 3-hydroxybutyric acid repeating unit. When the P3HA contains a 3HB repeating unit, from the viewpoint of the balance between flexibility and strength, the composition ratio of the 3HB repeating unit is preferably 60 mol % to 99 mol % in the total monomer repeating units (100 mol %), more preferably 61 mol % to 97 mol %, and still more preferably 62 mol % to 95 mol %. When the composition ratio of the 3HB repeating unit in the P3HA-based resin contained in the component (B) is 60 mol % or more, there is an advantage that the rigidity of the crosslinked resin particles (B) can be further improved. On the other hand, when the composition ratio of the 3HB repeating unit in the P3HA-based resin is 99 mol % or less, there is an advantage that the flexibility of the crosslinked resin particles (B) tends to be further improved. As the P3HA-based resin contained in the component (B), two or more types having different composition ratios of the 3HB repeating unit may be used in combination.

In the present specification, “polyglycolic acid” refers to a resin containing 50 mol % or more of a repeating unit represented by [—CH₂—CO—O—] out of the total monomer repeating units (100 mol %). The polyglycolic acid may contain 60 mol % or more, 70 mol % or more, 80 mol % or more, or 90 mol % or more of a repeating unit represented by [—CH₂—CO—O—] out of the total monomer repeating units (100 mol %).

The polyglycolic acid may be a homopolymer of glycolic acid, or a copolymer of glycolic acid with a monomer other than glycolic acid (such as a copolymer of glycolic acid and lactic acid, or a copolymer of glycolic acid and caprolactone).

The polyglycolic acid can be obtained by a known method, such as condensation polymerization of glycolic acid and ring opening polymerization of glycolide.

The PHA-based resin may have a glass transition temperature of 0° C. or lower, may have a glass transition temperature of higher than 0° C., or may be a mixture of a PHA-based resin having a glass transition temperature of 0° C. or lower and a PHA-based resin having a glass transition temperature of higher than 0° C. The glass transition temperature of the crosslinked resin particles (B) is preferably 0° C. or lower from the viewpoint that rigidity in a temperature region at or below room temperature tends to be high. From the viewpoint of setting the glass transition temperature of the crosslinked resin particles (B) to 0° C. or lower, the PHA-based resin contained in the crosslinked resin particles (B) preferably comprises a PHA-based resin having a glass transition temperature of 0° C. or lower. The PHA-based resin contained in the crosslinked resin particles (B) preferably comprises 60% by weight or more, more preferably 70% by weight or more, still more preferably 80% by weight or more, and particularly preferably 90% by weight or more of a PHA-based resin having a glass transition temperature of 0° C. or lower, in 100% by weight of all PHA-based resins contained in the crosslinked resin particles (B).

The glass transition temperature of the PHA-based resin is a temperature determined as a midpoint between a temperature at which a baseline shift starts and a temperature at which the baseline shift ends, the baseline shift occurring when 2 mg to 3 mg of the PHA-based resin is filled in an aluminum pan, the resin is completely melted by heating from −80° C. to 180° C. at a rate of 10° C./min under a nitrogen stream using a differential scanning calorimeter, then cooled from 180° C. to −80° C. at a rate of 10° C./min, and subsequently heated again from −80° C. to 180° C. at a rate of 10° C./min.

For example, among P3HA, the Tg of a copolymer of 3HB and a monomer other than 3HB may depend on the type of the monomer other than 3HB in the copolymer and the content ratio of the monomer. For example, P3HB3HH in which the 3HH repeating unit is 10 mol % or more out of 100 mol % of the repeating units of P3HB3HH has a Tg of lower than 0° C. For example, P3HB4HB in which the 4HB repeating unit is 6 mol % or more out of 100 mol % of the repeating units of P3HB4HB has a Tg of lower than 0° C.

The weight average molecular weight of the PHA-based resin is not particularly limited. The weight average molecular weight of the PHA-based resin is preferably 50,000 to 3,000,000, more preferably 100,000 to 2,000,000, and still more preferably 150,000 to 1,500,000. When the weight average molecular weight is 50,000 or more, there is an advantage that the tendency for the crosslinked resin particles (B) to have lower strength can be reduced or avoided. In addition, when the weight average molecular weight of the PHA-based resin is 50,000 or more, there is an advantage that the tendency for stickiness due to low molecular weight components can be reduced or avoided. On the other hand, a PHA-based resin having a weight average molecular weight of 3,000,000 or less has the advantage that the PHA-based resin can be easily produced, and/or has the advantage that the PHA can be easily handled to achieve the object of one embodiment of the present invention. The numerical value of the weight average molecular weight of the PHA-based resin is a value obtained by measurement using the PHA-based resin before performing crosslinking treatment.

### <Gel Fraction>

In the present specification, the “crosslinked resin particles” refer to resin particles having a crosslinked structure in which the molecular chains of the resin constituting the resin particles are bonded to each other, intramolecularly and/or intermolecularly. That is, the “crosslinked resin particles” may have a crosslinked structure in which the molecular chains of the resin component comprising the PHA-based resin are bonded to each other. The amount of the crosslinked structure in the crosslinked resin particles affects the gel fraction of the crosslinked resin particles; specifically, the larger the amount of the crosslinked structure, the higher the gel fraction. Since the crosslinked resin particles (B) have the crosslinked structure in a certain amount or more, they exhibit a high gel fraction, specifically a gel fraction of 50% or more. By the crosslinked resin particles (B) having a gel fraction of 50% or more, the crosslinked resin particles (B) have excellent hardness, heat resistance, and solvent resistance.

The value of the gel fraction is preferably 60% or more, more preferably 70% or more, still more preferably 75% or more, and particularly preferably 80% or more. Also, it may be 85% or more, or may be 90% or more. The upper limit of the gel fraction is not particularly limited, as long as it is 100% or less. From the viewpoint of production efficiency of the crosslinked resin particles (B), the upper limit of the gel fraction is preferably 99.5% or less, and more preferably 99% or less. Also, the upper limit of the gel fraction may be 98% or less, may be 97% or less, or may be 96% or less.

The gel fraction is a value measured as follows:
(1) A dried product of the crosslinked resin particles (B) is added to chloroform so as to achieve a concentration of 0.7% by weight, and the resulting mixture is held at 60° C. for 30 minutes to obtain a chloroform solution;
(2) Thereafter, the chloroform solution is allowed to stand at room temperature for 3 hours, and the chloroform solution is then filtered through a membrane filter having a pore size of 0.45 μm; and
(3) The gel remaining on the filter is dried, the weight of the dried gel is measured together with the filter, and the gel fraction is calculated according to the following expression:

$$Expression$$

$$Gel fraction ( \% ) = \{ ( Weight of the filter including the dried gel - Weight of the filter alone ) / Weight of the dried product of the crosslinked resin particles ( B ) used for the measured \} \times 100.$$

### <Volume Average Particle Diameter>

The volume average particle diameter of the crosslinked resin particles (B) is preferably 0.10 μm to 10.00 μm. According to this configuration, the crosslinked resin particles can be suitably used for various applications as will be described below. From the viewpoint of practical usability, the lower limit of the volume average particle diameter is more preferably 0.15 μm or more, and still more preferably 0.20 μm or more. Also, from the viewpoint of productivity (such as PHA production and/or crosslinking treatment), the upper limit of the volume average particle diameter is more preferably 8.00 μm or less, and still more preferably 5.00 μm or less.

In the present specification, the volume average particle diameter (MV) of the crosslinked resin particles is a value obtained by measurement using an aqueous dispersion in which the crosslinked resin particles are dispersed in an aqueous medium. More specifically, for a population of k crosslinked resin particles in total, the particle diameters of the individual crosslinked resin particles included in the population are denoted in ascending order as d1, d2, . . . , di, . . . , dk, and the volumes of these individual crosslinked resin particles are denoted as V1, V2, . . . , Vi, . . . , Vk (here, the volume of a crosslinked resin particle having a particle diameter of di is Vi). The volume average particle diameter (MV) of the crosslinked resin particles is a value calculated according to the following Expression (1), that is, Expression (2).

$$[ Expression 1 ]$$

$$MV = \frac{V 1 \cdot d 1 + V 2 \cdot d 2 + … Vi \cdot di + … Vk \cdot dk}{V 1 + V 2 + … Vi + … Vk} \qquad ( 1 )$$

$$MV = \frac{\sum ( Vi \cdot di )}{\sum ( Vi )} \qquad ( 2 )$$

It should be noted that a general-purpose measurement apparatus can be used as a measurement apparatus for the volume average particle diameter of the crosslinked resin particles in the aqueous dispersion (in other words, for the particle diameter and volume of the crosslinked resin particles), and examples of such an apparatus include Microtrac MT3300EXII manufactured by Nikkiso Co., Ltd.

### <Peroxide>

The crosslinked structure in the crosslinked resin particles (B) is not particularly limited, but it is preferable that the crosslinking is performed using a peroxide. That is, the crosslinked resin particles (B) are preferably crosslinked using a peroxide. When a peroxide is used, radicals generated by the decomposition of the peroxide act on the molecules of the resin constituting the resin particles (for example, PHA-based resin). As a result, a crosslinked structure can be formed by direct bonding between the molecular chains of the resin constituting the resin particles.

When the crosslinked resin particles (B) are those crosslinked using a peroxide, the aqueous dispersion containing the crosslinked resin particles (B) may contain substances derived from the peroxide used for introducing the crosslinked structure (such as decomposition products of the peroxide and unreacted peroxide). Alternatively, when the crosslinked resin particles (B) are those crosslinked using a peroxide, substances derived from the peroxide used for introducing the crosslinked structure (such as decomposition products of the peroxide and unreacted peroxide) may adhere to the surfaces or other parts of the obtained crosslinked resin particles (B). That is, when the crosslinked resin particles (B) are those crosslinked using a peroxide, the crosslinked resin particles (B) or the present resin composition may contain substances derived from the peroxide (such as decomposition products of the peroxide and unreacted peroxide). When the crosslinked resin particles (B) or the present resin composition contains substances derived from a peroxide, by analyzing the crosslinked resin particles (B) or the resin composition, it is found that the crosslinked resin particles (B) were crosslinked using a peroxide.

The peroxide may be an organic peroxide, or may be an inorganic peroxide. Since the gel fraction can be increased more efficiently, the peroxide is preferably an organic peroxide.

As the organic peroxide, it is preferable to use at least one selected from the group consisting of diacyl peroxides, alkyl peroxy esters, dialkyl peroxides, hydroperoxides, peroxy ketals, peroxy carbonates, and peroxy dicarbonates, in consideration of factors such as the heating temperature and/or heating time during the crosslinking treatment.

Specific examples of such an organic peroxide include butyl peroxyneodecanoate, octanoyl peroxide, dilauroyl peroxide, succinic peroxide, a mixture of toluoyl peroxide and benzoyl peroxide, benzoyl peroxide, bis(butylperoxy)trimethylcyclohexane, butyl peroxylaurate, dimethyl di(benzoylperoxy)hexane, bis(butylperoxy)methylcyclohexane, bis(butylperoxy)cyclohexane, butyl peroxybenzoate, butyl bis(butylperoxy)valerate, dicumyl peroxide, di-t-hexyl peroxide, t-butyl peroxy-2-ethylhexanoate, t-butyl peroxyisobutyrate, t-butyl peroxypivalate, t-hexyl peroxypivalate, t-butyl peroxymethyl monocarbonate, t-pentyl peroxymethyl monocarbonate, t-hexyl peroxymethyl monocarbonate, t-heptyl peroxymethyl monocarbonate, t-octyl peroxymethyl monocarbonate, 1,1,3,3-tetramethylbutyl peroxymethyl monocarbonate, t-butyl peroxyethyl monocarbonate, t-pentyl peroxyethyl monocarbonate, t-hexyl peroxyethyl monocarbonate, t-heptyl peroxyethyl monocarbonate, t-octyl peroxyethyl monocarbonate, 1,1,3,3-tetramethylbutyl peroxyethyl monocarbonate, t-butyl peroxy-n-propyl monocarbonate, t-pentyl peroxy-n-propyl monocarbonate, t-hexyl peroxy-n-propyl monocarbonate, t-heptyl peroxy-n-propyl monocarbonate, t-octyl peroxy-n-propyl monocarbonate, 1,1,3,3-tetramethylbutyl peroxy-n-propyl monocarbonate, t-butyl peroxyisopropyl monocarbonate, t-pentyl peroxyisopropyl monocarbonate, t-hexyl peroxyisopropyl monocarbonate, t-heptyl peroxyisopropyl monocarbonate, t-octyl peroxyisopropyl monocarbonate, 1,1,3,3-tetramethylbutyl peroxyisopropyl monocarbonate, t-butyl peroxy-n-butyl monocarbonate, t-pentyl peroxy-n-butyl monocarbonate, t-hexyl peroxy-n-butyl monocarbonate, t-heptyl peroxy-n-butyl monocarbonate, t-octyl peroxy-n-butyl monocarbonate, 1,1,3,3-tetramethylbutyl peroxy-n-butyl monocarbonate, t-butyl peroxyisobutyl monocarbonate, t-pentyl peroxyisobutyl monocarbonate, t-hexyl peroxyisobutyl monocarbonate, t-heptyl peroxyisobutyl monocarbonate, t-octyl peroxyisobutyl monocarbonate, 1,1,3,3-tetramethylbutyl peroxyisobutyl monocarbonate, t-butyl peroxy-sec-butyl monocarbonate, t-pentyl peroxy-sec-butyl monocarbonate, t-hexyl peroxy-sec-butyl monocarbonate, t-heptyl peroxy-sec-butyl monocarbonate, t-octyl peroxy-sec-butyl monocarbonate, 1,1,3,3-tetramethylbutyl peroxy-sec-butyl monocarbonate, t-butyl peroxy-t-butyl monocarbonate, t-pentyl peroxy-t-butyl monocarbonate, t-hexyl peroxy-t-butyl monocarbonate, t-heptyl peroxy-t-butyl monocarbonate, t-octyl peroxy-t-butyl monocarbonate, 1,1,3,3-tetramethylbutyl peroxy-t-butyl monocarbonate, t-butyl peroxy-2-ethylhexyl monocarbonate, t-pentyl peroxy-2-ethylhexyl monocarbonate, t-hexyl peroxy-2-ethylhexyl monocarbonate, t-heptyl peroxy-2-ethylhexyl monocarbonate, t-octyl peroxy-2-ethylhexyl monocarbonate, 1,1,3,3-tetramethylbutyl peroxy-2-ethylhexyl monocarbonate, diisobutyl peroxide, cumyl peroxyneodecanoate, di-n-propyl peroxydicarbonate, diisopropyl peroxydicarbonate, di-sec-butyl peroxydicarbonate, 1,1,3,3-tetramethylbutyl peroxyneodecanoate, bis(4-t-butylcyclohexyl) peroxydicarbonate, bis(2-ethylhexyl) peroxydicarbonate, t-hexyl peroxyneodecanoate, t-butyl peroxyneodecanoate, t-butyl peroxyneoheptanoate, t-hexyl peroxypivalate, t-butyl peroxypivalate, di(3,5,5-trimethylhexanoyl) peroxide, dilauroyl peroxide, 1,1,3,3-tetramethylbutyl peroxy-2-ethylhexanoate, disuccinic acid peroxide, 2,5-dimethyl-2,5-bis(2-ethylhexanoylperoxy)hexane, t-hexyl peroxy-2-ethyl hexanoate, di(4-methylbenzoyl) peroxide, dibenzoyl peroxide, t-butyl peroxy-2-ethylhexyl carbonate, t-butyl peroxyisopropyl carbonate, 1,6-bis(t-butylperoxycarbonyloxy)hexane, t-butyl peroxy-3,5,5-trimethylhexanoate, t-butyl peroxyacetate, t-butyl peroxybenzoate, t-amyl peroxy-3,5,5-trimethylhexanoate, 2,2-bis(4,4-di-t-butylperoxycyclohexyl) propane, and 2,2-di-t-butylperoxybutane. One of these organic peroxides may be used alone, or two or more thereof may be used in combination.

Among these, t-butyl peroxyisopropyl monocarbonate, t-pentyl peroxyisopropyl monocarbonate, t-hexyl peroxyisopropyl monocarbonate, t-butyl peroxy-2-ethylhexyl monocarbonate, t-pentyl peroxy-2-ethylhexyl monocarbonate, t-hexyl peroxy-2-ethylhexyl monocarbonate, t-amyl peroxyisopropyl monocarbonate, di-t-hexyl peroxide, t-butyl peroxy-2-ethylhexanoate, t-butyl peroxyisobutyrate, t-hexyl peroxy-2-ethylhexanoate, 1,1,3,3-tetramethylbutyl peroxy-2-ethylhexanoate, t-butyl peroxypivalate, t-hexyl peroxypivalate, t-butyl peroxyneodecanoate, t-hexyl peroxyneodecanoate, and 1,1,3,3-tetramethylbutyl peroxyneodecanoate are preferred organic peroxides because they can efficiently promote the crosslinking of the resin constituting the resin particles.

The peroxide is preferably a compound having a 1-hour half-life temperature of 200° C. or lower, more preferably a compound having a 1-hour half-life temperature of 170° C. or lower, and still more preferably a compound having a 1-hour half-life temperature of 140° C. or lower, since the heating temperature during the crosslinking treatment can be set low. The lower limit of the 1-hour half-life temperature of the peroxide may be 50° C. or higher, may be 60° C. or higher, or may be 70° C. or higher.

As the organic peroxide exhibiting such a 1-hour half-life temperature, t-butyl peroxyisopropyl monocarbonate, t-butyl peroxy-2-ethylhexyl monocarbonate, di-sec-butyl peroxydicarbonate, t-butyl peroxy-2-ethylhexanoate, t-butyl peroxyisobutyrate, t-hexyl peroxy-2-ethylhexanoate, 1,1,3,3-tetramethylbutyl peroxy-2-ethylhexanoate, t-butyl peroxypivalate, t-hexyl peroxypivalate, t-butyl peroxyneodecanoate, t-hexyl peroxyneodecanoate, and 1,1,3,3-tetramethylbutyl peroxyneodecanoate are particularly preferable.

A description will be given for the case where the peroxide is an inorganic peroxide. In consideration of the heating temperature and/or time during the crosslinking treatment, examples of the inorganic peroxide include hydrogen peroxide, potassium peroxide, calcium peroxide, sodium peroxide, magnesium peroxide, potassium persulfate, sodium persulfate, and ammonium persulfate. Among these, hydrogen peroxide, potassium persulfate, sodium persulfate, and ammonium persulfate are preferable in terms of ease of handling and having a decomposition temperature suited for the heating temperature during the crosslinking treatment. One of these inorganic peroxides may be used alone, or two or more thereof may be used in combination. Also, an organic peroxide and an inorganic peroxide may be used in combination.

### <Polyfunctional Compound>

The crosslinked structure in the crosslinked resin particles (B) may be one introduced using only the peroxide, but is preferably one introduced using both the peroxide and a polyfunctional compound. That is, the crosslinked resin particles (B) is preferably crosslinked in the presence of the peroxide and the polyfunctional compound. When both the peroxide and the polyfunctional compound are used, it becomes possible to increase the gel fraction of the crosslinked resin particles (B) with a smaller amount of peroxide, as compared with the case where only the peroxide is used.

The polyfunctional compound refers to a compound having, in one molecule, two or more functional groups (for example, radical reactive groups) capable of crosslinking the resin (for example, PHA-based resin) constituting the resin particles. The polyfunctional compound is not particularly limited, but a compound having reactivity with radicals generated from the peroxide is preferable, and a compound having, in one molecule, two or more radical reactive groups is particularly preferable. As the radical reactive group, at least one selected from the group consisting of a vinyl group, an allyl group, an acryloyl group, and a methacryloyl group is preferable.

Such a polyfunctional compound is not particularly limited, but examples thereof include allyl (meth)acrylate; allyl alkyl (meth)acrylates; allyloxyalkyl (meth)acrylates; polyfunctional (meth)acrylates having two or more (meth)acryl groups, such as ethylene glycol di(meth)acrylate, butanediol di(meth)acrylate, triethylene glycol di(meth)acrylate, tetraethylene glycol di(meth)acrylate, polyethylene glycol di(meth)acrylate, trimethylolpropane tri(meth)acrylate, and pentaerythritol (meth)acrylate; divinylbenzene, diallyl phthalate, triallyl cyanurate, triallyl isocyanurate, and divinylbenzene. The polyfunctional compound is preferably one or more selected from the group consisting of allyl methacrylate, triallyl isocyanurate, butanediol di(meth)acrylate, and divinylbenzene, and is particularly preferably one or more selected from the group consisting of allyl methacrylate and triallyl isocyanurate.

In the case where the crosslinked structure is formed in the presence of the polyfunctional compound, the obtained crosslinked resin particles (B) can normally contain a structure derived from the polyfunctional compound. In this case, the molecular chains of the resin constituting the resin particles become bonded to each other via the structure derived from the polyfunctional compound.

### <Other Components>

The crosslinked resin particles (B) may be constituted only by a PHA-based resin having a crosslinked structure, or may further contain components other than the PHA-based resin. Examples of the components other than the PHA-based resin having a crosslinked structure include a resin other than the PHA-based resin, an antioxidant, a hydrolysis inhibitor, a blocking inhibitor, a nucleating agent, a lubricant, and an ultraviolet absorber.

The proportion of the PHA-based resin in the crosslinked resin particles (B) is not particularly limited. The amount of the PHA-based resin in 100% by weight of the resin component of the crosslinked resin particles (B) may be 50% by weight or more, is preferably 70% by weight or more, more preferably 80% by weight or more, even more preferably 90% by weight or more, particularly preferably 95% by weight or more, and may be 99% by weight or more. The upper limit of the amount of the PHA-based resin in 100% by weight of the resin component of the crosslinked resin particles (B) is not particularly limited, as long as it is 100% by weight or less. It should be noted that the “resin component of the crosslinked resin particles (B)” refers to the resin that substantially constitutes the crosslinked resin particles (B), and does not include the component that crosslinks the molecular chains of the resin (for example, the structure derived from the polyfunctional compound) or residues of components used for crosslinking the molecular chains of the resin (for example, unreacted peroxide, decomposition products of the peroxide, unreacted polyfunctional compound, and the like).

Examples of the resin other than the PHA-based resin include aliphatic polyester other than the PHA-based resin and aliphatic-aromatic polyester. Examples of the aliphatic polyester other than PHA include (i) polycaprolactone (PCL), (ii) polylactic acid (PLA), and (iii) aliphatic polyester composed of a structure formed by polycondensation of an aliphatic diol and an aliphatic dicarboxylic acid. Specific examples of the aliphatic polyester having a structure formed by polycondensation of an aliphatic diol and an aliphatic dicarboxylic acid include polyethylene succinate, polybutylene succinate (hereinafter referred to as “PBS” in some cases), polyhexamethylene succinate, polyethylene adipate, polybutylene adipate, polyhexamethylene adipate, polybutylene succinate adipate (hereinafter referred to as “PBSA” in some cases), polyethylene sebacate, and polybutylene sebacate. Examples of the aliphatic-aromatic polyester include aliphatic-aromatic polyester obtained by using both an aliphatic compound and an aromatic compound as monomers and copolymerizing these monomers (using both an aliphatic compound and an aromatic compound as monomers). Examples of the aliphatic-aromatic polyester include polybutylene adipate terephthalate (hereinafter referred to as “PBAT” in some cases), polybutylene sebacate terephthalate (hereinafter referred to as “PBSeT” in some cases), polybutylene azelate terephthalate (hereinafter referred to as “PBAzT” in some cases), polybutylene succinate terephthalate (hereinafter referred to as “PBST” in some cases), and polybutylene succinate adipate terephthalate (hereinafter referred to as “PBSAT” in some cases). One of these resins other than the PHA-based resin may be used alone, or two or more thereof may be used in combination. In the crosslinked resin particles (B), the resin other than the PHA-based resin may be either crosslinked or not crosslinked.

The crosslinked resin particles (B) are different from foamed resin particles such as those disclosed in International Publication No. WO 2007/049694 and International Publication No. WO 2019/146555, and are preferably not foamed. In other words, it is preferable that the crosslinked resin particles (B) are substantially free from bubbles inside the particles. The expression “substantially free from bubbles inside the particles” is intended to mean that, in 100% by volume of the crosslinked resin particles, the volume of bubbles (voids) is 10% or less.

When the crosslinked resin particles (B) are not foamed, the apparent density of the crosslinked resin particles (B) exhibits a relatively large value. The apparent density of the crosslinked resin particles (B) is preferably more than 0.6 g/cm³, more preferably 0.7 g/cm³ or more, and still more preferably 0.9 g/cm³ or more. The apparent density of the crosslinked resin particles (B) can be determined by the method described in JIS K0061 (Test methods for density and relative density of chemical products) or JIS Z8807 (Methods of measuring density and specific gravity of solid).

The average weight per particle of the crosslinked resin particles (B) is not particularly limited. For example, when the volume average particle diameter of the crosslinked resin particles (B) is 10.00 μm or less, the average weight per particle of the crosslinked resin particles (B) can be a value far below 0.1 mg.

The crosslinked resin particles (B) may be in a dried state. The shape after drying can have a shape such as a powder form, a pellet form, a crumb form, a film form, or a sheet form, depending on the drying method.

### <Method for Producing Crosslinked Resin Particles (B)>

One example of a method for producing the crosslinked resin particles (B) will be specifically described. The crosslinked resin particles (B) can be produced by crosslinking the molecular chains of the resin in an aqueous dispersion containing resin particles before crosslinking treatment, in the presence of a peroxide. It should be noted that the term “resin particles” is intended to refer to particles constituted by the resin component that substantially constitutes the crosslinked resin particles. When the resin component is constituted only by the PHA-based resin, the resin particles can also be referred to as PHA-based resin particles. To efficiently crosslink the molecular chains of the resin, it is preferable to heat the aqueous dispersion of the resin particles containing the peroxide to a temperature suited for decomposition of the peroxide.

More specifically, it is preferable that the method for producing the crosslinked resin particles (B) includes: (1) a step of preparing an aqueous dispersion of resin particles in which resin particles before crosslinking treatment (for example, PHA-based resin particles) are dispersed in water; (2) a step of adding a peroxide to the aqueous dispersion of resin particles and impregnating the resin particles with the peroxide; and (3) a step of heating the aqueous dispersion of resin particles impregnated with the peroxide to a heating temperature to crosslink the molecular chains of the resin (for example, the molecular chains of the PHA-based resin). It is more preferable that the method further includes (4) a step of maintaining the heating temperature after all of the peroxide has been added.

In step (1), for example, the aqueous dispersion of PHA-based resin particles may be an aqueous dispersion obtained by culturing PHA-producing microorganisms to accumulate the PHA-based resin within the cells, then disrupting the cells in the culture solution, and separating and removing the cell components, or an aqueous dispersion obtained by concentrating or diluting the resulting aqueous dispersion. According to such methods, the processes from producing PHA-based resin particles by culturing the PHA-producing microorganisms to the crosslinking treatment can be carried out without separating the PHA-based resin particles from water.

Alternatively, the aqueous dispersion of resin particles (for example, PHA-based resin particles) can also be produced by dispersing dried resin particles (for example, PHA-based resin particles) in water.

The aqueous medium contained in the aqueous dispersion may be water alone, or may be a mixed solvent of water and an organic solvent miscible with water. In such a mixed solvent, the concentration of the organic solvent miscible with water is not particularly limited, as long as it does not exceed the solubility of the organic solvent used in water.

The organic solvent is not particularly limited, but examples thereof include alcohols such as methanol, ethanol, 1-propanol, 2-propanol, 1-butanol, 2-butanol, isobutanol, pentanol, hexanol, and heptanol; ketones such as acetone and methyl ethyl ketone; ethers such as tetrahydrofuran and dioxane; nitriles such as acetonitrile and propionitrile; amides such as dimethylformamide and acetamide; dimethyl sulfoxide; pyridine; and piperidine. Among these, methanol, ethanol, 1-propanol, 2-propanol, 1-butanol, 2-butanol, isobutanol, acetone, methyl ethyl ketone, tetrahydrofuran, dioxane, acetonitrile, propionitrile, and the like are preferable from the viewpoint of ease of removal. Also, methanol, ethanol, 1-propanol, 2-propanol, butanol, acetone, and the like are more preferable due to their ease of availability. Furthermore, methanol, ethanol, and acetone are particularly preferable.

The amount of water in the entire aqueous medium constituting the aqueous dispersion (100% by weight) is preferably 5% by weight to 100% by weight. The amount of water in 100% by weight of the aqueous medium is more preferably 10% by weight or more, more preferably 30% by weight or more, still more preferably 50% by weight or more, and particularly preferably 70% by weight or more. The amount of water in 100% by weight of the aqueous medium may also be 90% by weight or more, and may be 95% by weight or more.

It is preferable that, in the aqueous dispersion, the volume average particle diameter of the resin particles is within the same range as the volume average particle diameter of the above-described crosslinked resin particles (B). In the case of PHA-based resin particles produced by PHA-producing microorganisms, their volume average particle diameter may be normally within the above range, and therefore, an aqueous dispersion of PHA-based resin particles having a desirable volume average particle diameter can be obtained without carrying out any special step for adjusting the particle diameter.

The concentration of the resin particles in the aqueous dispersion is not particularly limited and may be set as appropriate, but for example, it may be about 1 to 70% by weight, and is preferably about 5 to 50% by weight.

The aqueous dispersion of resin particles preferably contains a dispersant in order to enhance the dispersibility of the resin particles and to allow the crosslinking reaction to proceed uniformly. Examples of the dispersant include anionic surfactants such as dioctyl sodium sulfosuccinate, sodium dodecyl sulfate, sodium lauryl sulfate, and sodium oleate; cationic surfactants such as lauryltrimethylammonium chloride; nonionic surfactants such as glycerin fatty acid esters, sorbitan fatty acid esters, sucrose fatty acid esters, polyoxyethylene alkyl ethers, polyoxyethylene alkylphenyl ethers, and polyoxyethylene-polyoxypropylene glycols; and water-soluble polymers such as polyvinyl alcohol, ethylene-modified polyvinyl alcohol, polyvinylpyrrolidone, methyl cellulose, ethyl cellulose, hydroxymethyl cellulose, hydroxyethyl cellulose, polyacrylic acid, sodium polyacrylate, potassium polyacrylate, polymethacrylic acid, and sodium polymethacrylate. One of these dispersants may be used alone, or two or more thereof may be used in combination.

When a dispersant is used, the amount (added amount) of the dispersant in the aqueous dispersion is not particularly limited. The amount of the dispersant in the aqueous dispersion is, for example, 0.1 parts by weight to 10 parts by weight, preferably 0.5 parts by weight to 5 parts by weight, and more preferably 0.5 parts by weight to 3 parts by weight, based on 100 parts by weight of the resin particles.

In step (2), a peroxide is added to the aqueous dispersion of resin particles obtained in step (1) to impregnate the resin particles with the peroxide. As the peroxide, those described above can be used. The peroxide can be added in various forms such as a solid form or a liquid form. Also, a liquid form diluted with a diluent or the like may be added. The peroxide may be added all at once, or may be added continuously or in divided portions.

When the peroxide and the polyfunctional compound described above are used in combination, it is preferable that the polyfunctional compound is also added to the aqueous dispersion of resin particles in step (2). As the polyfunctional compound, those described above can be used. The polyfunctional compound may be added in various forms such as a solid form or a liquid form. A liquid form diluted with a diluent or the like may also be added. The polyfunctional compound may be added all at once, or may be added continuously or in divided portions.

In step (2), as a method for impregnating the resin particles with the peroxide and the optional polyfunctional compound, there may be mentioned a method in which, after adding these compounds to the aqueous dispersion of resin particles, or while adding them, the temperature of the aqueous dispersion is set to, for example, 0° C. or higher and lower than a temperature suited for decomposition of the peroxide employed in the subsequent step (3), and while stirring the aqueous dispersion, the temperature is maintained for, for example, about 1 minute to 5 hours. Specifically, the temperature of the aqueous dispersion at the time of impregnation may be about 0° C. to 80° C.

The amount of the peroxide used can be set as appropriate in consideration of the gel fraction of the crosslinked resin particles (B). The amount of the peroxide used is preferably 0.01 parts by weight to 10 parts by weight, more preferably 0.1 parts by weight to 8 parts by weight, still more preferably 0.3 parts by weight to 5 parts by weight, and particularly preferably 0.5 parts by weight to 3 parts by weight, based on 100 parts by weight of the resin particles.

According to the production method in which the resin particles are crosslinked in an aqueous dispersion by using a peroxide, it is easy to allow the crosslinking to proceed while maintaining the particle diameter (volume) before crosslinking, thereby obtaining the crosslinked resin particles (B). On the other hand, a method in which the resin is crosslinked by melt kneading in the presence of a peroxide may have difficulty in achieving this.

Also, according to the production method in which the resin particles are crosslinked in an aqueous dispersion by using a peroxide, it is easy to control the temperature increase caused by the heat generated during the crosslinking reaction, and there is an advantage that crosslinked resin particles (B) having a safe and stable crosslinked structure (quality) can be efficiently obtained.

Also, the amount of the polyfunctional compound used may be set as appropriate in consideration of the gel fraction of the crosslinked resin particles (B). The amount of the polyfunctional compound used is preferably 0.01 parts by weight to 20 parts by weight, more preferably 0.05 parts by weight to 15 parts by weight, still more preferably 0.1 parts by weight to 10 parts by weight, even more preferably 0.2 parts by weight to 5 parts by weight, and particularly preferably 0.3 parts by weight to 3 parts by weight, based on 100 parts by weight of the resin particles.

In step (3), the aqueous dispersion of resin particles impregnated with the peroxide is heated to a temperature suited for decomposition of the peroxide. The heating temperature is preferably within a range of about 25° C. above and below the 1-hour half-life temperature exhibited by the peroxide described above (1-hour half-life temperature−25° C. to 1-hour half-life temperature+25° C.). Specifically, the heating temperature is preferably 30° C. to 140° C., more preferably 50° C. to 135° C., and still more preferably 60° C. to 130° C. According to the present method, since the resin (for example, PHA-based resin) can be crosslinked at a temperature lower than the melting temperature of the resin, deterioration of the resin due to heating during the crosslinking treatment can be avoided. It should be noted that the melting temperature of the PHA-based resin is, for example, 50° C. to 210° C.

In the subsequent step (4), it is preferable to maintain the above-described heating temperature. As a result, the crosslinking reaction using the peroxide can be sufficiently advanced. The time for maintaining the heating temperature is not particularly limited, but is preferably 1 minute to 15 hours, and more preferably 1 hour to 10 hours.

After completion of the crosslinking reaction, by separating the crosslinked resin particles (B) from the aqueous dispersion and removing water from the separated crosslinked resin particles (B), dried crosslinked resin particles (B) can be obtained. A method for separating the crosslinked resin particles (B) from the aqueous dispersion is not particularly limited, and for example, filtration, centrifugal separation, drying with heating, freeze drying, spray drying, or the like can be used. For example, when spray drying is used, dried crosslinked resin particles (B) can be obtained directly from the aqueous dispersion. Also, by extruding the crosslinked resin particles (B) by themselves after separating them from the aqueous dispersion, it is also possible to obtain the crosslinked resin particles (B) in the form of pellets while completely removing the residual moisture. In addition, a coagulation step by the use of a coagulant and/or by pH adjustment may be carried out.

### [1-3] Other Components Contained in the Present Resin Composition

### <Nucleating Agent>

The present resin composition may further comprise a nucleating agent. By the thermoplastic resin composition comprising a nucleating agent, when the P3HA-based resin component (A) is a crystalline resin, crystallization during molding can be promoted, thereby improving moldability, productivity, and other properties. When the present resin composition comprises a nucleating agent, there is also an advantage that a thermoplastic resin composition and a molded article thereof excellent in heat resistance or mechanical properties can be obtained.

The nucleating agent is not particularly limited, and conventionally known nucleating agents can be used. Examples of the nucleating agent include: inorganic substances such as talc, kaolinite, montmorillonite, mica, synthetic mica, clay, zeolite, silica, carbon black, graphite, boron nitride, zinc oxide, titanium oxide, tin oxide, calcium carbonate, magnesium carbonate, aluminum oxide, neodymium oxide, barium sulfate, sodium chloride, and metal phosphates; sugar alcohol compounds derived from natural products such as erythritol, pentaerythritol, galactitol, mannitol, and arabitol; polysaccharides such as chitin and chitosan; polyols such as aliphatic alcohols (polyols), polyvinyl alcohol, and polyethylene oxide; organic carboxylic acid metal salts such as sodium benzoate, potassium benzoate, lithium benzoate, calcium benzoate, magnesium benzoate, barium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluate, sodium salicylate, potassium salicylate, zinc salicylate, aluminum dibenzoate, potassium dibenzoate, lithium dibenzoate, sodium β-naphthalate, and sodium cyclohexanecarboxylate; organic sulfonic acid salts such as sodium p-toluenesulfonate and sodium sulfoisophthalate; carboxylic acid amides such as ethylenebisstearamide, ethylenebislauramide, palmitamide, hydroxystearamide, erucamide, and trimesic acid tris(t-butylamide); carboxylic acid esters such as lauric acid esters, palmitic acid esters, oleic acid esters, stearic acid esters, erucic acid esters, N-oleyl palmitate, N-oleyl oleate, N-oleyl stearate, N-stearyl oleate, N-stearyl stearate, N-stearyl erucate, methylene bisstearate, ethylene bislaurate, ethylene bisscaprate, ethylene bisoleate, ethylene bisstearate, ethylene biserucate, ethylene bisisostearate, butylene bisstearate, and p-xylylene bisstearate; dicarboxylic acid derivatives such as dimethyl adipate, dibutyl adipate, diisodecyl adipate, and dibutyl sebacate; cyclic compounds having a functional group C═O and one or more functional groups selected from NH, S, and O in the molecule, such as indigo, quinacridone, and quinacridone magenta; sorbitol-based derivatives such as bisbenzylidene sorbitol and bis(p-methylbenzylidene) sorbitol; compounds containing a nitrogen-containing heteroaromatic nucleus, such as pyridine, triazine, and imidazole; phosphoric acid ester compounds, bisamides of higher fatty acids, and metal salts of higher fatty acids; branched polylactic acid; and low molecular weight poly-3-hydroxybutyrate. One of these nucleating agents may be used alone, or two or more thereof may be used in combination.

The amount of the nucleating agent is not particularly limited as long as it can promote crystallization of the thermoplastic resin. The amount of the nucleating agent is preferably 0.05 parts by weight to 12.00 parts by weight, more preferably 0.10 parts by weight to 10.00 parts by weight, and still more preferably 0.50 parts by weight to 8.00 parts by weight, based on 100 parts by weight of the P3HA-based resin component (A). When the amount of the nucleating agent is within the above range, the effect as a nucleating agent can be obtained while suppressing a decrease in viscosity during molding and a decrease in physical properties of a molded article.

### <Lubricant>

The present resin composition may further comprise a lubricant. When the thermoplastic resin composition contains a lubricant, the surface smoothness of the resulting molded article can be improved. The lubricant is not particularly limited. Examples of the lubricant include, but are not limited to, fatty acid metal salts such as magnesium stearate and calcium stearate; fatty acid amides such as behenamide, stearamide, erucamide, oleamide, methylenebis(stearamide), and ethylenebis(stearamide); polyethylene wax; oxidized polyester wax; glycerin mono-fatty acid esters such as glycerin monostearate, glycerin monobehenate, and glycerin monolaurate; organic acid monoglycerides such as succinic acid saturated fatty acid monoglycerides; sorbitan fatty acid esters such as sorbitan behenate, sorbitan stearate, and sorbitan laurate; polyglycerin fatty acid esters such as diglycerin stearate, diglycerin laurate, tetraglycerin stearate, tetraglycerin laurate, decaglycerin stearate, and decaglycerin laurate; and higher alcohol fatty acid esters such as stearyl stearate. One of these lubricants may be used alone, or two or more thereof may be used in combination.

The amount of the lubricant (when a plurality of lubricants are used, the total amount thereof) is not particularly limited as long as lubricity can be imparted to the molded article. The amount of the lubricant is preferably 0.01 parts by weight to 20.00 parts by weight, more preferably 0.05 parts by weight to 10.00 parts by weight, still more preferably 0.10 parts by weight to 10.00 parts by weight, even more preferably 0.20 parts by weight to 5.00 parts by weight, and particularly preferably 0.30 parts by weight to 4.00 parts by weight, based on 100 parts by weight of the P3HA-based resin component (A). When the amount of the lubricant is within the above range, the effect as a lubricant can be obtained while avoiding bleed-out of the lubricant to the molded article surface.

### <Other Components>

The present resin composition can contain other components such as a plasticizer; an organic filler; an inorganic filler; an antioxidant; a hydrolysis inhibitor; an ultraviolet absorber; a colorant such as a dye or a pigment; and an antistatic agent to the extent that the functions of the resulting molded article are not impaired.

The plasticizer is not particularly limited. Examples of the plasticizer may include polyester-based plasticizers such as polypropylene glycol sebacate; aliphatic dibasic acid ester-based plasticizers such as di-1-butyl adipate, di-n-butyl sebacate, and di-2-ethylhexyl azelate; glycerin-based plasticizers such as glycerin diacetomonolaurate, glycerin diacetomonocaprylate, and glycerin diacetomonodecanoate; polyvalent carboxylic acid ester-based plasticizers such as tri-2-ethylhexyl acetylcitrate and tributyl acetylcitrate; polyalkylene glycol-based plasticizers such as polyethylene glycol, polypropylene glycol, poly(ethylene oxide-propylene oxide) block and/or random copolymers, and polytetramethylene glycol; phosphate ester-based plasticizers such as diphenyl 2-ethylhexyl phosphate and diphenyl octyl phosphate; epoxy-based plasticizers such as epoxidized soybean oil and epoxidized linseed oil fatty acid butyl ester; and castor oil-based plasticizers such as castor oil fatty acid esters, methyl ricinoleate, ethyl ricinoleate, isopropyl ricinoleate, butyl ricinoleate, ethylene glycol monoricinoleate, propylene glycol monoricinoleate, trimethylolpropane monoricinoleate, sorbitan monoricinoleate, castor oil fatty acid polyethylene glycol esters, castor oil ethylene oxide adducts, castor oil-based polyols, castor oil-based triols, and castor oil-based diols. One of these plasticizers may be used alone, or two or more thereof may be used in combination.

The organic filler is not particularly limited. Examples of the organic filler include fillers constituted by materials derived from natural sources such as woody materials (for example, wood chips, wood flour, sawdust, and the like), rice husks, rice flour, starch, corn starch, rice straw, wheat straw, and natural rubber; organic fibers such as plant-based natural fibers, animal-based natural fibers, and synthetic fibers; and fillers constituted by materials of synthetic resins such as polyester, polyacrylic, polyamide, nylon, polyethylene, polyolefin, polyvinyl alcohol, polyvinyl chloride, polyurethane, polyacetal, aramid, PBO (poly-p-phenylene benzobisoxazole), polyphenylene sulfide, acetyl cellulose, polybenzazole, polyarylate, polyvinyl acetate, and synthetic rubber.

The plant-based natural fibers are not particularly limited. Examples of the plant-based natural fibers include kenaf fibers, abaca fibers, bamboo fibers, jute fibers, hemp fibers, linen fibers, henequen (sisal hemp), ramie fibers, hemp, cotton, banana fibers, coconut fibers, coco, palm, kozo, mitsumata, and bagasse. Also included are regenerated fibers processed from plant fibers, such as pulp, cellulose fibers, and rayon. Examples of the animal-based natural fibers include wool, silk, cashmere, and mohair.

The inorganic filler is not particularly limited. Examples of the inorganic filler include silica-based inorganic fillers (for example, quartz, fumed silica, anhydrous silicic acid, fused silica, crystalline silica, amorphous silica, fillers formed by condensation of alkoxysilanes, ultrafine amorphous silica, and the like), alumina, zircon, iron oxide, zinc oxide, titanium oxide, silicon nitride, boron nitride, aluminum nitride, silicon carbide, glass, silicone rubber, silicone resin, titanium oxide, carbon fibers, mica, graphite, carbon black, ferrite, graphite, diatomaceous earth, kaolin, clay, talc, calcium carbonate, manganese carbonate, magnesium carbonate, barium sulfate, and silver powder. These inorganic fillers may be surface-treated in order to improve dispersibility in the thermoplastic resin composition. Also, one of these inorganic fillers may be used alone, or two or more thereof may be used in combination.

The antioxidant is not particularly limited. Examples of the antioxidant include phenol-based antioxidants, phosphorus-based antioxidants, and sulfur-based antioxidants. One of these antioxidants may be used alone, or two or more thereof may be used in combination.

The hydrolysis inhibitor is not particularly limited. Examples of the hydrolysis inhibitor include carbodiimide compounds, epoxy compounds, isocyanate compounds, and oxazoline compounds. One of these hydrolysis inhibitors may be used alone, or two or more thereof may be used in combination.

The ultraviolet absorber is not particularly limited. Examples of the ultraviolet absorber include benzophenone-based compounds, benzotriazole-based compounds, triazine-based compounds, salicylic acid-based compounds, cyanoacrylate-based compounds, and nickel complex salt-based compounds. One of these ultraviolet absorbers may be used alone, or two or more thereof may be used in combination.

The colorant such as a pigment or a dye is not particularly limited. Examples of the colorant include inorganic colorants such as titanium oxide, calcium carbonate, chromium oxide, cuprous oxide, calcium silicate, iron oxide, carbon black, graphite, titanium yellow, and cobalt blue; soluble azo pigments such as lake red, lithol red, and brilliant carmine; insoluble azo pigments such as dinitrian orange and fast yellow; phthalocyanine pigments such as monochlorophthalocyanine blue, polychlorophthalocyanine blue, and polybromophthalocyanine green; condensed polycyclic pigments such as indigo blue, perylene red, isoindolinone yellow, and quinacridone red; and dyes such as Oracet Yellow. One of these colorants may be used alone, or two or more thereof may be used in combination.

The antistatic agent is not particularly limited. Examples of the antistatic agent include low molecular weight antistatic agents such as fatty acid ester compounds, aliphatic ethanolamine compounds, and aliphatic ethanolamide compounds; and polymeric antistatic agents. One of these antistatic agents may be used alone, or two or more thereof may be used in combination.

The present resin composition can also contain a catalyst deactivator (such as a hindered phenol-based compound, a thioether-based compound, a vitamin-based compound, a triazole-based compound, a polyvalent amine-based compound, a hydrazine derivative-based compound, or a phosphorus-based compound), a mold release agent (such as montanic acid or a salt thereof, an ester thereof, a half-ester thereof, stearyl alcohol, stearamide, or polyethylene wax), a coloration inhibitor (such as a phosphite or a hypophosphite), a silane coupling agent (such as an epoxy silane coupling agent, an amino silane coupling agent, a (meth)acrylic silane coupling agent, or an isocyanate silane coupling agent), a flame retardant (such as red phosphorus, a phosphate ester, brominated polystyrene, brominated polyphenylene ether, brominated polycarbonate, aluminum hydroxide, magnesium hydroxide, melamine or cyanuric acid or a salt thereof, or a silicon compound), a conductive agent (such as carbon black), a sliding property improver (such as graphite or a fluororesin), an epoxy compound (such as a glycidyl ether compound, a glycidyl ester compound, or a polymeric compound obtained by grafting or copolymerizing a glycidyl compound), an acid anhydride compound (such as maleic anhydride, succinic anhydride, or a polymeric compound obtained by grafting or copolymerizing an acid anhydride), a carbodiimide compound (such as N,N′-di-2,6-diisopropylphenyl carbodiimide, 2,6,2′,6′-tetraisopropyldiphenyl carbodiimide, or polycarbodiimide), or the like.

The amount of each of the other components described above is not particularly limited as long as the effects of one embodiment of the present invention can be achieved, and may be set as appropriate by those skilled in the art.

### [2. Method for Producing Thermoplastic Resin Composition]

In one embodiment of the present invention, there is provided a method for producing a thermoplastic resin composition, the method comprising a mixing step in which the component (A) and the component (B) are mixed. In the present specification, the “method for producing a thermoplastic resin composition according to one embodiment of the present invention” may be referred to as “method for producing the present resin composition” in some cases. The “method for producing the present resin composition” can be suitably used as a method for producing “the present resin composition”.

Specific aspects of the component (A), the component (B), and other components used in the method for producing the present resin composition are the same as those described in the above section [1. Thermoplastic Resin Composition]. Accordingly, the description thereof is incorporated by reference, and explanation is omitted in this section.

### <Mixing Step>

The method for producing the present resin composition comprises a mixing step in which the component (A), the component (B), and, as necessary, other components are mixed. In the mixing step, the amount of each component blended becomes the amount of each component in the resulting thermoplastic resin composition. Therefore, in the mixing step, each component is mixed so that the amount of each component in the resulting thermoplastic resin composition becomes a desired amount.

The mixing step is not particularly limited as long as it is a method by which the component (A) and the component (B) are mixed, and can be carried out by a known method. The mixing step can be carried out by, for example, a method in which the P3HA-based resin component (A), the crosslinked resin particles (B), optionally a nucleating agent and/or a nucleating agent, and other components are mixed using an extruder, a kneader, a Banbury mixer, a kneading roll, or the like. The mixing step may comprise a melt kneading step in which the present crosslinked resin particles (B) and the P3HA-based resin component (A) are melt kneaded. When melt kneading is performed, it is preferable to carry out mixing while paying attention to a decrease in the molecular weight of the component (A) due to thermal decomposition. Alternatively, the thermoplastic resin composition can also be produced by dissolving each component in a soluble solvent and then removing the solvent.

When producing the thermoplastic resin composition by melt kneading, each component may be individually fed into an extruder or the like, or a mixture obtained by premixing the respective components may be fed into an extruder or the like. For example, after mixing an aqueous dispersion of the P3HA-based resin component (A) with an aqueous dispersion of the crosslinked resin particles (B), the resulting mixed solution may be dried in a dryer to obtain a mixed powder, and the mixed powder may be fed into an extruder or the like.

When melt kneading is performed using an extruder, the obtained thermoplastic resin composition may be processed into particle shapes such as bar-shaped, cylindrical, elliptic cylindrical, spherical, cubic, or rectangular parallelepiped by extruding the thermoplastic resin composition from the extruder in a strand form and then cutting the extruded strands.

The resin temperature during melt kneading cannot be unconditionally specified because it depends on the melting point, melt viscosity, and other properties of the resin to be used. From the viewpoint of uniformly dispersing the crosslinked resin particles (B) in the P3HA-based resin component (A) while avoiding thermal decomposition of the P3HA-based resin component (A), the resin temperature during melt kneading is preferably 140° C. to 250° C., more preferably 150° C. to 230° C., and still more preferably 160° C. to 210° C.

### [3. Molded Article]

In one embodiment of the present invention, there is provided a molded article comprising the present resin composition. Hereinafter, the “molded article according to one embodiment of the present invention” may be referred to as “the present molded article” in some cases. The present molded article can also be said to be a molded article formed by molding the present resin composition. In providing the present molded article, the method for molding the present resin composition is not particularly limited, and generally used molding methods can be applied. Specific examples of the molding method include inflation film molding, extrusion blow molding, injection blow molding, extrusion molding, calender molding, vacuum molding, and injection molding. The molded article formed by molding the present resin composition may also be referred to as a molded article comprising the present resin composition.

By carrying out the above-described molding method using the present resin composition, a molded article excellent in tensile impact strength, specifically a film molded article, a sheet molded article, a blow molded product, an extrusion molded product, a vacuum molded product, or an injection molded product, can be produced with good productivity. In other words, the present molded article may be a film molded article, a sheet molded article, a blow molded product, an extrusion molded product, a vacuum molded product, or an injection molded product. In the present specification, the term “film molded article” conforms to JIS 20108:2012 and specifically refers to a thin film-shaped body having a thickness of less than 0.25 mm. In the present specification, the term “sheet molded article” conforms to JIS 20108:2012 and specifically refers to a thin plate-shaped body having a thickness of 0.25 mm or more.

The present molded article can be suitably used in agriculture, fisheries, forestry, horticulture, medicine, sanitary products, the food industry, clothing, non-clothing applications, packaging, automobiles, building materials, and other fields.

### <Tensile Strain>

The present molded article is a molded article improved so that tensile strain is increased. In the present specification, the tensile strain of a molded article can be evaluated by a tensile test. A specific method for measuring the tensile strain will be described in detail in Examples described below.

The larger the tensile strain measured by the above method, the molded article to be measured can be said to be a molded article superior in impact fracture resistance (less likely to undergo fracture due to impact).

The tensile strain of the present molded article is preferably 16% or more, more preferably 18% or more, and still more preferably 20% or more. A tensile strain of the molded article of 16% or more means that the molded article has excellent toughness. The upper limit of the tensile strain of the present molded article is not particularly limited, but it may be 200% or less, for example.

### SUMMARY

One embodiment of the present invention includes the following configurations.
[1] A thermoplastic resin composition comprising a poly(3-hydroxyalkanoate)-based resin component (A) and crosslinked resin particles (B) comprising a polyhydroxyalkanoate-based resin and having a gel fraction of 50% or more, wherein the poly(3-hydroxyalkanoate)-based resin component (A) contains:
a poly(3-hydroxyalkanoate)-based copolymer (a-1) having a weight average molecular weight of 200,000 to 1,000,000; and
a poly(3-hydroxyalkanoate)-based copolymer (a-2) having a weight average molecular weight larger than that of the poly(3-hydroxyalkanoate)-based copolymer (a-1).
[2] The thermoplastic resin composition according to [1], wherein the poly(3-hydroxyalkanoate)-based copolymer (a-2) is a copolymer of a 3-hydroxybutyrate unit and another hydroxyalkanoate unit other than the 3-hydroxybutyrate unit, and
a composition ratio of the 3-hydroxybutyrate unit is 77 mol % to 99 mol %.
[3] The thermoplastic resin composition according to [1] or [2], wherein an amount of the poly(3-hydroxyalkanoate)-based copolymer (a-1) is 80 parts by weight to 99 parts by weight based on 100 parts by weight of the poly(3-hydroxyalkanoate)-based resin component (A).
[4] The thermoplastic resin composition according to any one of [1] to [3], wherein a weight average molecular weight of the poly(3-hydroxyalkanoate)-based copolymer (a-2) is larger than a weight average molecular weight of the poly(3-hydroxyalkanoate)-based copolymer (a-1) by 200,000 or more.
[5] The thermoplastic resin composition according to any one of [1] to [4], wherein the poly(3-hydroxyalkanoate)-based copolymer (a-1) and/or (a-2) is at least one selected from the group consisting of poly(3-hydroxybutyrate-co-3-hydroxyhexanoate), poly(3-hydroxybutyrate-co-4-hydroxybutyrate), poly(3-hydroxybutyrate-co-3-hydroxypropionate), poly(3-hydroxybutyrate-co-3-hydroxyvalerate), poly(3-hydroxybutyrate-co-3-hydroxyoctanoate), poly(3-hydroxybutyrate-co-3-hydroxyoctadecanoate), poly(3-hydroxybutyrate-co-3-hydroxydecanoate), and poly(3-hydroxybutyrate-co-3-hydroxyvalerate-co-3-hydroxyhexanoate).
[6] The thermoplastic resin composition according to any one of [1] to [5], wherein the poly(3-hydroxyalkanoate)-based copolymer (a-1) and/or (a-2) is poly(3-hydroxybutyrate-co-3-hydroxyhexanoate).
[7] The thermoplastic resin composition according to any one of [1] to [6], wherein the poly(3-hydroxyalkanoate)-based copolymer (a-1) is a copolymer of a 3-hydroxybutyrate unit and another hydroxyalkanoate unit other than the 3-hydroxybutyrate unit, and
a composition ratio of the 3-hydroxybutyrate unit is 77 mol % to 99 mol %.
[8] The thermoplastic resin composition according to any one of [1] to [7], comprising 10 parts by weight to 60 parts by weight of the crosslinked resin particles (B) based on 100 parts by weight of a total amount of the poly(3-hydroxyalkanoate)-based resin component (A) and the crosslinked resin particles (B).
[9] The thermoplastic resin composition according to any one of [1] to [8], wherein the crosslinked resin particles (B) have a volume average particle diameter of 0.10 μm to 10.00 μm or less.
[10] The thermoplastic resin composition according to any one of [1] to [9], wherein the crosslinked resin particles (B) are those crosslinked using a peroxide.
[11] The thermoplastic resin composition according to [10], wherein the crosslinked resin particles (B) are those crosslinked in the presence of the peroxide and a polyfunctional compound.
[12] The thermoplastic resin composition according to any one of [1] to [11], wherein a proportion of the polyhydroxyalkanoate-based resin in 100% by weight of a resin component of the crosslinked resin particles (B) is 80% by weight or more.
[13] A molded article comprising the thermoplastic resin composition according to any one of [1] to [12].
[14] The molded article according to [13], which is a sheet, a film, a blow molded product, an extrusion molded product, a vacuum molded product, or an injection molded product.

### EXAMPLES

Hereinafter, the present invention will be specifically described by way of Examples; however, the technical scope of the present invention is not limited by these Examples.

### [Measurement Method]

### <Measurement of Monomer Composition Ratio in P3HB3HH>

The monomer composition ratio in P3HB3HH was determined by the following method. To about 20 mg of P3HB3HH was added 1 mL of a concentrated sulfuric acid (98%)-methanol mixed solution (15:85 in volume ratio) and 1 mL of chloroform, the mixture was sealed, and then heated at 100° C. for 140 minutes to obtain methyl esters of P3HB3HH decomposition products. After cooling the mixed solution containing the resulting decomposition products, 0.5 mL of deionized water was added thereto, the mixture was thoroughly mixed, and then left to stand until an aqueous layer and an organic layer were separated. Thereafter, the compositional features of monomers in the P3HB3HH decomposition products in the separated organic layer was analyzed by capillary gas chromatography. From the obtained peak areas, the ratio of 3-hydroxyhexanoate was calculated.

### <Weight Average Molecular Weight>

The resin to be measured was added to chloroform, and the resulting mixture was heated in a warm water bath at 60° C. for 30 minutes. The obtained mixture (chloroform-dissolved product) was filtered through a PTFE disposable filter having a pore size of 0.45 μm. Thereafter, using the obtained filtrate, GPC measurement was performed under the following conditions to determine the weight average molecular weight.
GPC measurement apparatus: High performance liquid chromatograph 20A system manufactured by Shimadzu Corporation
Columns: K-G 4A (one column) and K-806M (two columns) manufactured by Showa Denko K.K.
Sample concentration: 1 mg/ml
Eluent: chloroform solution
Eluent flow rate: 1.0 ml/min
Sample injection volume: 100 μL
Analysis time: 30 minutes
Standard sample: standard polystyrene.

### <Volume Average Particle Diameter>

The volume average particle diameter of the crosslinked resin particles was measured using an aqueous dispersion of the crosslinked resin particles as a sample. As a measurement apparatus, Microtrac MT3300EXII manufactured by Nikkiso Co., Ltd. was used. Specifically, using the above-described apparatus, the particle diameter and volume of each crosslinked resin particle in the aqueous dispersion of the crosslinked resin particles were measured, and based on the results obtained by the measurement, the volume average particle diameter was calculated in accordance with the above-described Expression (1), that is, Expression (2).

### <Gel Fraction>

A dried product of the crosslinked resin particles was added to chloroform so as to achieve a concentration of 0.7% by weight, and the resulting mixture was dissolved at 60° C. for 30 minutes to obtain a chloroform solution. Thereafter, the chloroform solution was allowed to stand at room temperature for 3 hours, and the chloroform solution was then filtered through a membrane filter having a pore size of 0.45 μm. Filtration was performed while sufficiently washing the inside of the container and the filter by pouring chloroform thereover a plurality of times, thereby preventing loss. The gel remaining on the filter was dried, and the weight thereof together with the filter was measured. The gel fraction was calculated according to the following expression:

$$Expression$$

$$Gel fraction = ( Weight of the filter including the dried gel - Weight of the filter alone ) / Weight of the crosslinked resin particles used for the measured \times 100 ( \% ) .$$

### <Evaluation of Tensile Strain>

The thermoplastic resin compositions obtained in Examples 1 to 6 and Comparative Examples 1 to 4 were kneaded for 2 minutes using a test roll mill manufactured by Kansai Roll Co., Ltd. (diameter: 8 inches, length: 20 inches) under conditions of a set temperature of 140° C. and rotation speeds of 17 rpm for the front roll and 16 rpm for the rear roll, to produce sheets so that the sheets had a thickness of 0.5 mm. Two sheet pieces cut out from the obtained sheets were stacked so as to be oriented in directions perpendicular to each other, and were hot pressed using a compression molding machine manufactured by Shinto Metal Industries, Ltd. (ASFA-37H/C) at a set temperature of 160° C. and a pressure of 10 MPa to a thickness of 1 mm, thereby producing a press sheet. The obtained press sheet was cut into the JIS K 6251 No. 2 shape to produce a test specimen for tensile testing. For the test specimen, a tensile test was carried out under the following conditions using Autograph AG-X manufactured by Shimadzu Corporation, and tensile strain was evaluated. Test specimen size: thickness 1.0 mm, length (between chucks) 50 mm or more, and width 20 mm
Temperature: 23° C.
Tensile speed: 2 mm/min
Distance between chucks: 50 mm
Gauge length: 20 mm.

### [Production Example: Production of Crosslinked Resin Particles]

### <Raw Materials for Crosslinked Resin Particles>

### (Uncrosslinked Resin Particles)

P3HB3HH-28: P3HB3HH (average content ratio 3HB/3HH=72/28 (mol %/mol %), weight average molecular weight of 700,000, Tg of −7° C., manufactured by Kaneka Corporation) The weight average molecular weight of the uncrosslinked resin particles was measured by the method described above.

### (Peroxide)

Di-sec-butyl peroxydicarbonate (“Luperox (R) 225” manufactured by ARKEMA Yoshitomi, Ltd., 1-hour half-life temperature: 69° C.).

### (Polyfunctional Compound)

Triallyl isocyanurate.

### <Production of Crosslinked Resin Particles>

Into an autoclave equipped with a stirrer, a baffle, a nitrogen inlet/outlet, and a thermometer were added an aqueous dispersion in which the uncrosslinked resin particles were dispersed in water (100 parts by weight in terms of solid content), 200 parts by weight of deionized water, 2 parts by weight of the peroxide, 2 parts by weight of dioctyl sodium sulfosuccinate, and 0.5 parts by weight of the polyfunctional compound, to prepare an aqueous dispersion. Stirring of the obtained aqueous dispersion was started at room temperature, and at the same time, the inside of the autoclave was purged with nitrogen. Thereafter, the aqueous dispersion in the autoclave was stirred at room temperature (20 to 25° C.) for 1 hour, thereby impregnating the interior of the uncrosslinked resin particles with the peroxide and the polyfunctional compound.

Thereafter, the aqueous dispersion was heated to 75° C. After the aqueous dispersion reached 75° C., the reaction was carried out by maintaining the heating temperature at the reaction temperature for 3.5 hours, thereby obtaining an aqueous dispersion in which crosslinked resin particles were dispersed in water.

After adjusting the pH of the aqueous dispersion, the aqueous dispersion was dried in an oven to obtain solidified crosslinked resin particles.

With respect to the obtained crosslinked resin particles, as a result of measuring the volume average particle diameter and the gel fraction by the above-described measurement methods, the volume average particle diameter was 1.70 μm, and the gel fraction was 95%.

### Examples 1 to 6 and Comparative Examples 1 to 4: Production of Thermoplastic Resin Composition

### <Raw Materials for Thermoplastic Resin Composition>

### (Poly(3-Hydroxyalkanoate)-Based Resin Component)

P3HB3HH-6: powder of P3HB3HH (average content ratio 3HB/3HH=94/6 (mol %/mol %), weight average molecular weight of 400,000, manufactured by Kaneka Corporation, Kaneka biodegradable polymer GreenPlanet (registered trademark)) was used
P3HB3HH-6H: powder of P3HB3HH (average content ratio 3HB/3HH=94/6 (mol %/mol %), weight average molecular weight of 760,000, manufactured by Kaneka Corporation, Kaneka biodegradable polymer GreenPlanet (registered trademark)) was used.
P3HB3HH-11H: powder of P3HB3HH (average content ratio 3HB/3HH=89.5/10.5 (mol %/mol %), weight average molecular weight of 780,000, manufactured by Kaneka Corporation, Kaneka biodegradable polymer GreenPlanet (registered trademark)) was used

The weight average molecular weight of the poly(3-hydroxyalkanoate)-based resin was measured by the method described above.

### (Crosslinked Resin Particles)

Crosslinked resin particles produced in Production Example

### (Nucleating Agent)

Erucamide: Neutron-S manufactured by Nippon Fine Chemical Co., Ltd.

### (Lubricant)

Behenamide: BNT22H manufactured by Nippon Fine Chemical Co., Ltd.

### <Production of Thermoplastic Resin Composition>

### Examples 1 to 6 and Comparative Examples 1 to 4

For each Example, the poly(3-hydroxyalkanoate)-based resin, the nucleating agent, and the lubricant described in Table 1 were mixed in the amounts shown in Table 1, and the crosslinked resin particles described in Table 1 were mixed thereto in the amount described in Table 1 to obtain a mixture. The obtained mixture was melt kneaded for 180 seconds under conditions of a screw rotation speed of 100 rpm using a small twin screw kneader (Xplore MC5 manufactured by DSM) with the barrel temperature heated to 175° C., thereby obtaining a melt kneaded product (mixture). Using the obtained melt kneaded product, a sheet was produced by the method described above in Evaluation of Tensile Strain, and evaluation of tensile strain was carried out. The results are shown in Table 1.

TABLE 1

| | | | | | | | | | Compar- | Compar- | Compar- | Compar- |
|---|---|---|---|---|---|---|---|---|---|---|---|---|
| | | | Exam- | Exam- | Exam- | Exam- | Exam- | Exam- | ative | ative | ative | ative |
| | | | ple 1 | ple 2 | ple 3 | ple 4 | ple 5 | ple 6 | Example 1 | Example 2 | Example 3 | Example 4 |
| P3HA- | (a-1) | P3HB3HH-6 | 76.5 | 63 | 49.5 | 76.5 | 63 | 49.5 | 90 | 90 | 70 | 100 |
| based resin | | (Mw = 400,000) | | | | | | | | | | |
| component | (a-2) | P3HB3HH-6H | 8.5 | 7 | 5.5 | | | | 10 | | | |
| (parts by | | (Mw = 760,000) | | | | | | | | | | |
| weight) | | P3HB3HH-11H | | | | 8.5 | 7 | 5.5 | | 10 | | |
| | | (Mw = 780,000) | | | | | | | | | | |

| Crosslinked resin particles (B) (parts by | | 15 | 30 | 45 | 15 | 30 | 45 | | | 30 | |
|---|---|---|---|---|---|---|---|---|---|---|---|
| weight) | | | | | | | | | | | |
| Component | (a-1)/[(a-1) + (a-2)] | 0.9 | 0.9 | 0.9 | 0.9 | 0.9 | 0.9 | 0.9 | 0.9 | | |
| ratio (parts by | (B)/[(A) + (B) + (C)] | 0.15 | 0.3 | 0.45 | 0.15 | 0.3 | 0.45 | | | 0.3 | |
| weight) | | | | | | | | | | | |
| Additive | Nucleating agent | 0.5 | 0.5 | 0.5 | 0.5 | 0.5 | 0.5 | 0.5 | 0.5 | 0.5 | 0.5 |
| (parts by | Lubricant | 0.5 | 0.5 | 0.5 | 0.5 | 0.5 | 0.5 | 0.5 | 0.5 | 0.5 | 0.5 |
| weight) | | | | | | | | | | | |

| | | | | | | | | | | |
|---|---|---|---|---|---|---|---|---|---|---|
| Tensile strain (%) | 21 | 26 | 32 | 25 | 33 | 40 | 12 | 13 | 15 | 8 |

From Table 1, Examples 1 to 3 yielded results in which tensile strain was significantly improved as compared with Comparative Examples 1, 3, and 4. Also, Examples 4 to 6 yielded results in which tensile strain was significantly improved as compared with Comparative Examples 2, 3, and 4.

From the above results, it can be understood that, as in Examples 1 to 6, when the P3HA-based resin (a-1), the P3HA-based resin (a-2), and the crosslinked resin particles were used in combination, results were obtained in which tensile strain was significantly improved as compared with the case where they were not used in combination as in Comparative Examples 1 to 4.

In addition, from a comparison between Examples 1 to 3, in which a P3HA-based resin having an average content ratio of 3HB/3HH of 94/6 (mol %/mol %) was used as the P3HA-based resin (a-2), and Examples 4 to 6, in which a P3HA-based resin having an average content ratio of 3HB/3HH of 89.5/10.5 (mol %/mol %) was used, it can be understood that Examples 4 to 6 using the P3HA-based resin having an average content ratio of 3HB/3HH of 89.5/10.5 (mol %/mol %) yielded results in which tensile strain was further improved.

According to one embodiment of the present invention, there can be provided a novel thermoplastic resin composition capable of providing a molded article having a large tensile strain. Therefore, one embodiment of the present invention can be suitably used in agriculture, fisheries, forestry, horticulture, medicine, sanitary products, the food industry, clothing, non-clothing applications, packaging, automobiles, building materials, and other fields.

1. A thermoplastic resin composition comprising:
a poly(3-hydroxyalkanoate)-based resin component (A) and
crosslinked resin particles (B) comprising a polyhydroxyalkanoate-based resin and having a gel fraction of at least 50%,
wherein the poly(3-hydroxyalkanoate)-based resin component (A) comprises
a poly(3-hydroxyalkanoate)-based copolymer (a-1) having a weight average molecular weight of from 200,000 to 1,000,000; and
a poly(3-hydroxyalkanoate)-based copolymer (a-2) having a weight average molecular weight larger than that of the poly(3-hydroxyalkanoate)-based copolymer (a-1).

2. The thermoplastic resin composition according to claim 1, wherein the poly(3-hydroxyalkanoate)-based copolymer (a-2) is a copolymer of a 3-hydroxybutyrate unit and another hydroxyalkanoate unit other than the 3-hydroxybutyrate unit, and
a composition ratio of the 3-hydroxybutyrate unit is from 77 mol % to 99 mol %.

3. The thermoplastic resin composition according to claim 1, wherein an amount of the poly(3-hydroxyalkanoate)-based copolymer (a-1) is from 80 parts by weight to 99 parts by weight based on 100 parts by weight of the poly(3-hydroxyalkanoate)-based resin component (A).

4. The thermoplastic resin composition according to claim 1, wherein a weight average molecular weight of the poly(3-hydroxyalkanoate)-based copolymer (a-2) is larger than a weight average molecular weight of the poly(3-hydroxyalkanoate)-based copolymer (a-1) by at least 200,000.

5. The thermoplastic resin composition according to claim 1, wherein the poly(3-hydroxyalkanoate)-based copolymer (a-1) and/or (a-2) is at least one selected from the group consisting of poly(3-hydroxybutyrate-co-3-hydroxyhexanoate), poly(3-hydroxybutyrate-co-4-hydroxybutyrate), poly(3-hydroxybutyrate-co-3-hydroxypropionate), poly(3-hydroxybutyrate-co-3-hydroxyvalerate), poly(3-hydroxybutyrate-co-3-hydroxyoctanoate), poly(3-hydroxybutyrate-co-3-hydroxyoctadecanoate), poly(3-hydroxybutyrate-co-3-hydroxydecanoate), and poly(3-hydroxybutyrate-co-3-hydroxyvalerate-co-3-hydroxyhexanoate).

6. The thermoplastic resin composition according to claim 1, wherein the poly(3-hydroxyalkanoate)-based copolymer (a-1) and/or (a-2) is poly(3-hydroxybutyrate-co-3-hydroxyhexanoate).

7. The thermoplastic resin composition according to claim 1, wherein the poly(3-hydroxyalkanoate)-based copolymer (a-1) is a copolymer of a 3-hydroxybutyrate unit and another hydroxyalkanoate unit other than the 3-hydroxybutyrate unit, and
a composition ratio of the 3-hydroxybutyrate unit is from 77 mol % to 99 mol %.

8. The thermoplastic resin composition according to claim 1, comprising from 10 parts by weight to 60 parts by weight of the crosslinked resin particles (B) based on 100 parts by weight of a total amount of the poly(3-hydroxyalkanoate)-based resin component (A) and the crosslinked resin particles (B).

9. The thermoplastic resin composition according to claim 1, wherein the crosslinked resin particles (B) have a volume average particle diameter of from 0.10 μm to 10.00 μm.

10. The thermoplastic resin composition according to claim 1, wherein the crosslinked resin particles (B) are crosslinked using a peroxide.

11. The thermoplastic resin composition according to claim 10, wherein the crosslinked resin particles (B) are crosslinked in the presence of the peroxide and a polyfunctional compound.

12. The thermoplastic resin composition according to claim 1, wherein a proportion of the polyhydroxyalkanoate-based resin in 100% by weight of a resin component of the crosslinked resin particles (B) is at least 80% by weight.

13. A molded article comprising the thermoplastic resin composition according to claim 1.

14. The molded article according to claim 13, which is a sheet, a film, a blow molded product, an extrusion molded product, a vacuum molded product, or an injection molded product.
